(19) United States
(12) Patent Application Publication
(10) Pub. No.: US 2014/0060857 A1
(43) Pub. Date: Mar. 6, 2014

(54) Combination Rasping/Filing Tool

(71) Applicants: Juan G. Ortega, Medellin - Antioquia (CO); Andres Montoya, Rionegro - Antioquia (CO); Carlos A. Lara, Avon, CT (US)

(72) Inventors: Juan G. Ortega, Medellin - Antioquia (CO); Andres Montoya, Rionegro - Antioquia (CO); Carlos A. Lara, Avon, CT (US)

(21) Appl. No.: 14/020,064

(22) Filed: Sep. 6, 2013

Related U.S. Application Data
(60) Provisional application No. 61/697,367, filed on Sep. 6, 2012.

(51) Int. Cl. A01L 11/00

(52) U.S. Cl. CPC A01L 11/00
USPC 168/48.1

(57) ABSTRACT

A combination rasping/filing tool comprises an axially extending blade having first and second surfaces and proximal and distal ends. The first surface has a plurality of rasping teeth. Each individual rasping tooth defines a rasping cavity projecting below the first surface and has a raised portion projecting away from said first surface a height h. The raised portion has a trailing shoulder extending proximally away from and contiguous with a sharpened rasping ledge. A rasping face is contiguous with the rasping ledge and projects into the rasping cavity. Each rasping tooth is arranged in a row of a plurality of teeth, and each row is staggered in relation to proximally and distally neighboring rows. In one embodiment each row comprises eight teeth.

### BACKGROUND OF THE DISCLOSURE

The present disclosure relates to cutting tools, and more particularly, to a combination rasp and file utilized by farriers in preparing the hoof of an ungulate, particularly horses, to be reshod.

Before reshoeing a hoofed animal, a farrier must remove old horn material to provide a flat, structurally sound surface on which to attach the new shoe. The shoeing nails will not securely fasten the shoe to the hoof if the old horn material is not removed, and as a result the animal may “throw its shoe.” The process of reshoeing a hoof is typically performed every six to eight weeks, and is particularly important in ensuring the health of horses trained for competition in racing and show jumping.

Removing the old horn material traditionally requires that the farrier manipulate the lower part of the horse's leg, and place the horse's foot between his legs. While grasping the horse's foot between his legs, the farrier must remove the old nails and horse shoe, file down the old horn material, and nail the new shoe to the horse's hoof. The farrier must work accurately to ensure that the shoe is securely attached to the horse's hoof. The farrier must also work quickly to avoid irritating the horse while the farrier is in a vulnerable position.

U.S. Pat. No. 4,598,447 discloses a typical prior art farrier's file/rasping tool. Traditional farrier's file/rasping tools are approximately two inches wide and approximately 12 inches long. One side of the tool has a rasping surface having a number of raised teeth. The teeth are arranged six to a row, and each row is staggered in comparison to the neighboring rows. A file surface is located opposite the rasping surface.

The traditional farrier's file/rasping tools are light and easy to manipulate one-handed. Despite the advantages of traditional tools, the rasping surface can become clogged, especially when shoeing an animal having softer, damper horn material. The more clogged the rasping surface becomes, the more passes a farrier must make with the tool in order to provide a structurally adequate surface to which the farrier must attach each shoe.

In traditional rasping tools to which the present disclosure relates, manufacturing practicalities of forming the rasping teeth resulted in the rasping surface being offset from the opposed edges of the tool so that planar surfaces or bands extended from the edges to the raised rasping surface. By not configuring the raised rasping surface to extend completely from one edge of the tool to the other edge of the tool, there was less effective frictional resistance during usage of the tool and the tool could be more easily manipulated and used.

### SUMMARY

According to aspects of the disclosure, a rasping/filing tool comprises an axially extending blade having first and second working surfaces and proximal and distal ends.

The first surface of the blade has a plurality of rasping teeth. The rasping teeth have a diamond-shaped outline when viewed from a top perspective. Each individual rasping tooth has a raised portion which projects away from the first surface at an angle. Each raised portion has a rasping ledge and a trailing shoulder portion. Each rasping tooth also defines a rasping cavity. The rasping cavity has an inverse half pyramidal shape. The height and angle of the raised portion and the depth of the rasping cavity may be adjusted as best suits the characteristics of the hoof material for which the tool is intended.

The rasping teeth of the tool are arranged in a plurality of laterally extending rows which extend substantially the entire width of the first working surface. Each row preferably has eight teeth. The rows are staggered in relation to proximally and distally neighboring rows, and arranged longitudinally on the blade such that the proximal-most end of the trailing shoulder of each distally-neighboring row of teeth is received adjacent the rasping cavity of at least one tooth in a proximally-neighboring row of teeth.

The second working surface of the blade has a first plurality of parallel filing ridges. The first plurality of parallel filing ridges is oriented in a first angular direction with respect to the longitudinal axis of the tool. A second plurality of parallel filing ridges is oriented in a second angular direction with respect to the longitudinal axis. The first and second angular directions are oriented transverse to one another. A plurality of scalloped filing teeth are formed where the first and second plurality of ridges intersect. The second working surface has a finer surface than the first working surface, and is intended for precise adjustments to the hoof.

In comparison to the prior art six teeth per row configuration, the eight teeth per row tool disclosed herein provides a more efficient rasping surface. By adding an additional two teeth to each row, a farrier can remove more horn material with each pass of the rasping/filing tool and work more efficiently with each pass of the rasping/filing tool.

### BRIEF DESCRIPTION OF THE DRAWING

Aspects of the preferred embodiment will be described in reference to the Drawing, where like numerals reflect like elements:

FIG. 1 is a top view of a first working surface of one embodiment of a rasping/filing tool;

FIG. 2 is a top view of one embodiment of a single rasping tooth of the embodiment of the rasping/filing tool depicted in FIG. 1; neighboring rasping teeth are omitted for clarity;

FIG. 3 is a cross sectional view along axis B-B of the single rasping tooth depicted in FIG. 2;

FIG. 4 is a side view of the embodiment of the rasping/filing tool depicted in FIG. 1; and

FIG. 5 is a top view of a second working surface of the rasping/filing tool depicted in FIG. 1.

### DETAILED DESCRIPTION OF THE PREFERRED EMBODIMENT

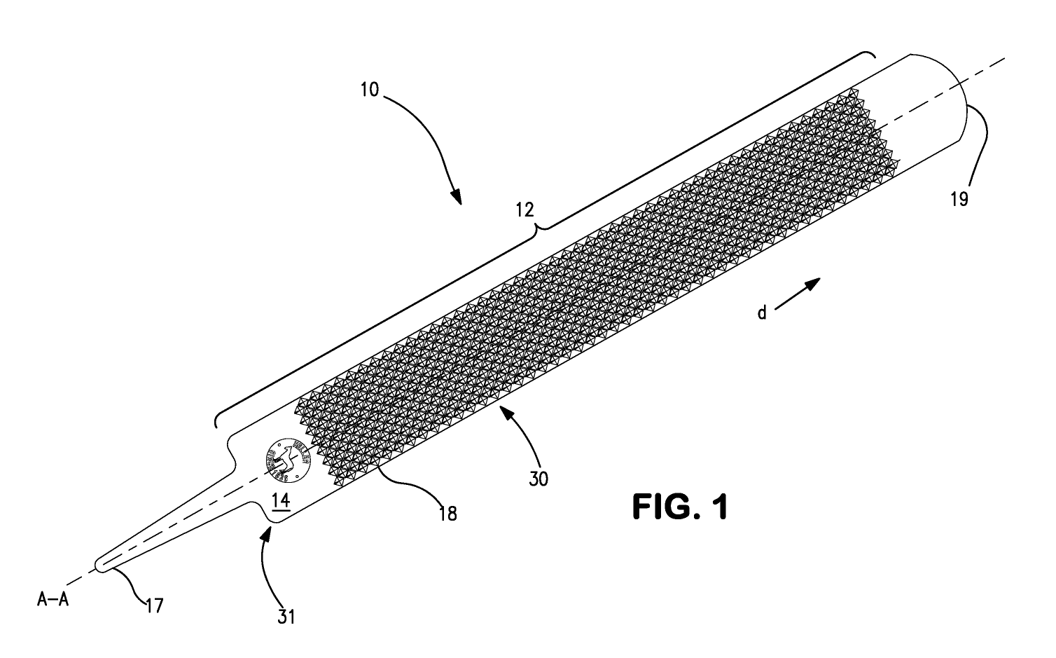

Embodiments of a rasping/filing tool 10 will now be described with reference to the Figures wherein like numerals represent like parts throughout FIGS. 1-5.

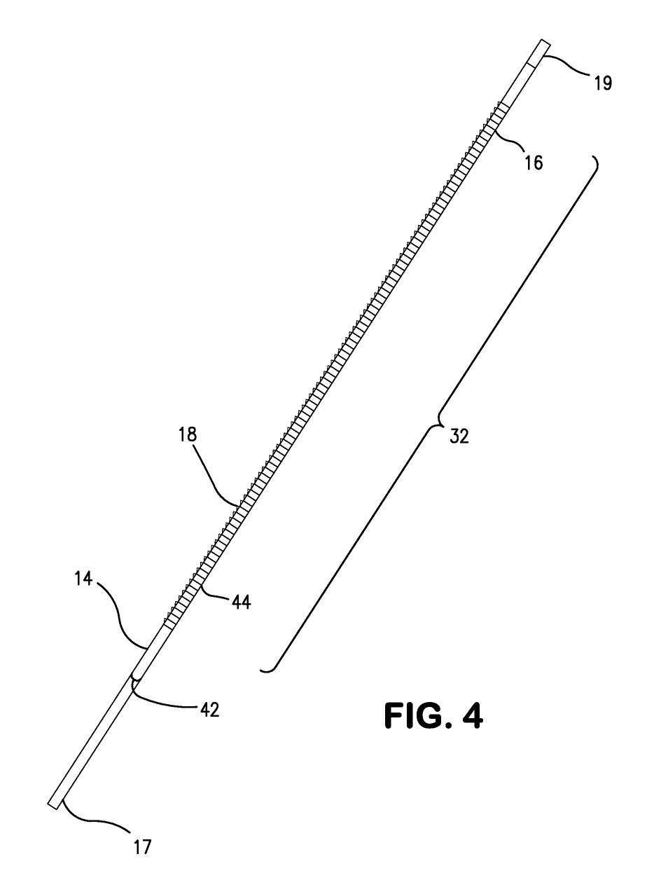

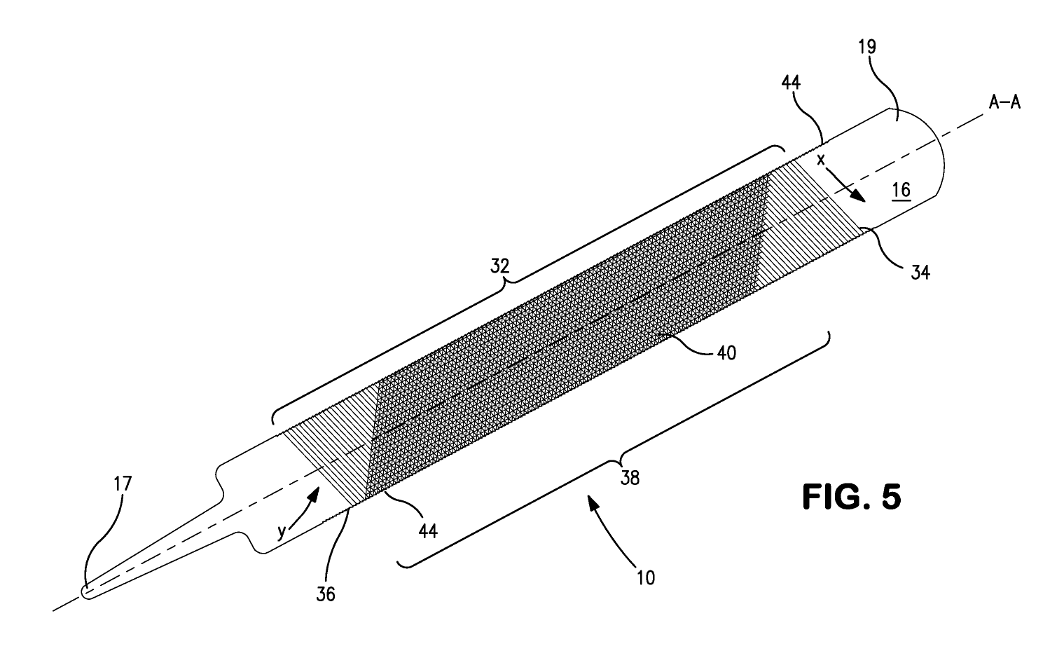

One embodiment of the rasping/filing tool 10 is illustrated in FIG. 1. The rasping/filing tool has a longitudinal axis A-A. A blade 12 extends the axial length of the tool 10. The blade 12 has a first and second working surface 14 and 16 (FIGS. 4 and 5), respectively. The blade 12 also has proximal and distal ends 17 and 19, respectively. In one embodiment, the distal end 19 has a rounded hand hold, and the proximal end 17 has a tang for insertion into a reusable handle (not shown).

In one embodiment, the blade first surface 14 has a plurality of rasping teeth 18. With reference to FIG. 3, each individual rasping tooth 18 has a raised portion 20. The raised portion 20 projects above the first surface 14, and projects away from a plane defined by the first surface 14 at an angle θ. The height h that the raised portion 20 projects above the first surface 14 may be increased or decreased along a range between 0.047 and 0.037 inches. The angle θ at which the raised portion 20 projects away from the first surface may be increased or decreased with respect to the first surface 14. The angle θ and the height h at which the raised portion 20 projects from the first surface 14 may depend upon a number of variables, including the type of hoof for which the rasping/filing tool 10 is designed.

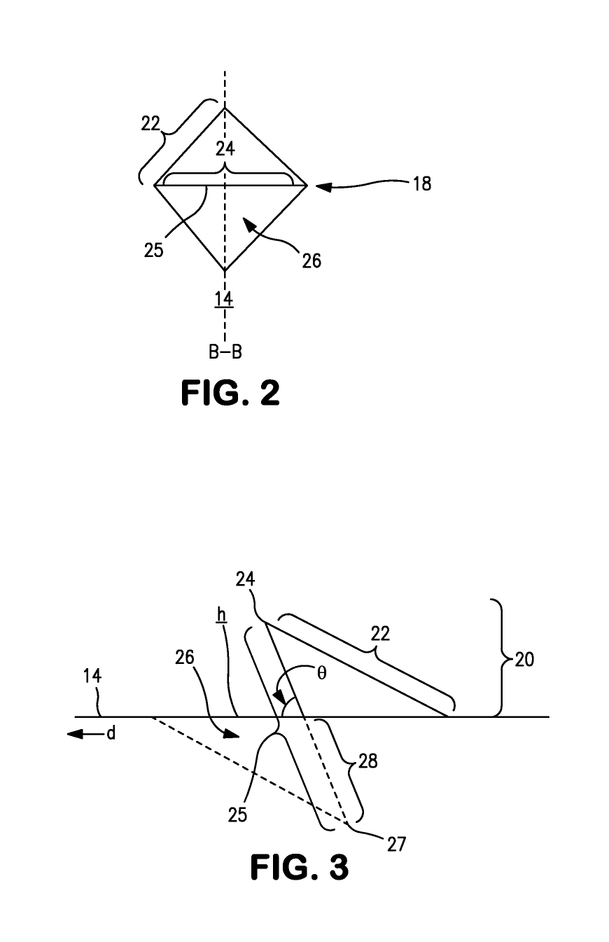

As shown in FIG. 2, each individual rasping tooth 18 has a diamond like outline when viewed from a top perspective. The raised portion 20 has a trailing shoulder portion 22, and a sharpened rasping ledge 24. Each individual rasping tooth defines a rasping cavity 26 having an inverse half pyramidal shape. A rasping face 25, contiguous with the sharpened rasping ledge 24, extends from the sharpened rasping ledge 24 to the bottom 27 of the rasping cavity 26. Like the angle at which the raised portion projects from the first surface 14, a depth 28 of the rasping cavity 26 may also be modified to prevent horn material from clogging the rasping teeth 18.

With reference to FIG. 3, as the farrier draws the first surface 14 of the rasping/filing tool 10 across the hoof (not shown) in a direction d, the sharpened rasping ledge 24 removes horn material. In one embodiment, shown in FIG. 1, the direction d is oriented from the proximal end 17 towards the distal end 19. If the hoof is particularly soft and the angle θ is too steep and/or the depth 28 of each tooth 18 is too deep, horn material will clog the rasping cavity 26. The more material that clogs the rasping cavity 26, the less efficient the first surface 14 will be in removing horn material.

As illustrated in FIG. 1, each individual rasping tooth 18 is arranged in a plurality of rows 30 that extend laterally across the blade 12. The teeth 18 are arranged eight to a row 30. The teeth 18 in each row 30 are packed tightly together, with one tooth 18 per row formed at a perimeter 31 of the blade 12. Adding two additional teeth 18 on each row 30 increases the effective contact surface of the rasping teeth 18 on a hoof in comparison with prior art farrier's rasps. The additional two teeth 18 per row 30 allow the blade 12 to glide more easily along even dry, hard hooves of thoroughbred horses. As such, designing the blade 12 to have eight teeth 18 per row 30 allows the farrier to more smoothly and more evenly remove horn material from a hoof with each pass as compared to prior art farrier's rasps. The eight teeth 18 per row 30 design leaves fewer imperfections on the surface of the animal's hoof, and thus a better finish after using the blade first surface 14.

In one embodiment the rows of eight teeth are arranged on a surface 14 having a length selected from a range between approximately 13.5 inches and approximately 15 inches, and a width selected from a range between approximately 1.625 Inches and approximately 1.875 inches. Arranging eight teeth on a surface 14 having the dimensions recited above provides the benefits of an eight toothed rasp while remaining easy to manipulate with a single hand.

The teeth 18 in each row 30 are staggered and arranged longitudinally on the blade 12 such that the proximal-most end of the trailing shoulder 24 of each distally neighboring row of teeth 30 is received adjacent the rasping cavity 26 of at least one tooth 18 in a proximally neighboring row 30. In one embodiment, the rows 30 are configured such that the distal-most end of each rasping cavity 26 in a proximally neighboring row of rasping teeth aligns with the rasping ledge 24 of each tooth in the distally neighboring row of teeth 30.

In an embodiment of the rasping/filing tool 10 depicted in FIG. 5, the blade second surface 16 has a filing surface 32. The filing surface 32 comprises a first plurality of parallel filing ridges 34 formed in the second surface 16. The first plurality of ridges 34 is oriented in a first angular direction “x” with respect to the longitudinal axis A-A. A second plurality of parallel filing ridges 36 is oriented in a second angular direction “y” with respect to the longitudinal axis A-A. The first angular direction x is transverse to the second angular direction y, and the first plurality of ridges 34 intersect the second plurality of ridges 36 over a working portion 38 of the second surface 16. The intersection between the first and second plurality of ridges 34 and 36 creates a plurality of scalloped filing teeth 40.

Once a farrier has removed a significant portion of hoof material with the first surface 14, the farrier may make fine adjustments to the hoof with the second surface 16. The intersecting first and second pluralities of ridges 34 and 36 produce a finer surface and remove less horn material per pass than the rasping teeth 18 on the first surface 14. As such, the farrier may work quickly with the first surface 14 to remove large amounts of dead horn material and use the second surface 16 to smooth out the hoof material. For instance, the farrier may use the second surface to smooth out small bumps in the horn material that were not removed by the first surface 14, ensuring that the hoof has a uniform flat surface to which to attach the new shoe.

In one embodiment shown in FIGS. 4 and 5, the blade 12 has a depth 42 extending between the first and second surface 14 and 16 of the tool 10. A plurality of side ridges 44 are formed spanning the depth 42. The side ridges 44 are formed along substantially the entire longitudinal length of the blade 12 corresponding to the filing surface 32.

While a preferred embodiment has been set forth for purposes of illustration, the foregoing description should not be deemed a limitation of the invention herein. Accordingly, various modifications, adaptations and alternatives may occur to one skilled in the art without departing from the scope of the claimed coverage.

1. A combination rasping/filing tool having a longitudinal axis a length and a width, and comprising:
an axially extending blade having first and second surfaces and proximal and distal ends;
said first surface having a plurality of rasping teeth extending a substantial extent of the length of said blade, each individual rasping tooth defining a rasping cavity projecting below said first surface and having a raised portion projecting away from said first surface a height h and at an angle θ with respect to said first surface, said raised portion having a trailing shoulder portion extending proximally away from and contiguous with a sharpened rasping ledge and a rasping face contiguous with said rasping ledge, said rasping face projecting into said rasping cavity and defining a bottommost point of said rasping cavity, wherein each rasping tooth is arranged in a row of a plurality of teeth extending substantially the entire width of said blade, each row is staggered in relation to proximally and distally neighboring rows such that a proximal-most end of said trailing shoulder of each rasping tooth in one row is received adjacent said rasping cavity of at least one tooth in a proximally neighboring row.

2. The combination rasping/filing tool of claim 1, wherein each of said rows of a plurality of teeth comprises eight teeth.

3. The combination rasping/filing tool of claim 2, wherein said first surface has a length selected from a range between approximately 13.5 inches and approximately 15 inches, and a width selected from a range between approximately 1.625 Inches and approximately 1.875 inches.

4. The combination rasping/filing tool of claim 1, wherein the height h is selected along a range between approximately 0.047 inches and approximately 0.037 inches.

5. The combination rasping/filing tool of claim 1, wherein a plurality of side ridges project laterally from a longitudinal periphery of said blade, each ridge spanning a depth of said blade between said first and second surfaces.

6. The combination rasping/filing tool of claim 1, wherein said second surface has a first plurality of filing ridges oriented parallel to one another in a first angular direction with respect to the longitudinal axis, and a second plurality of filing ridges oriented parallel to one another in a second angular direction with respect to the longitudinal axis and intersecting said first plurality of filing rows, wherein said first angular direction is transverse to said second angular direction, and said first and second filing rows form a plurality of scalloped filing teeth where said first and second rows intersect.

7. The combination rasping/filing tool of claim 6, wherein said first and second surfaces are configured for use on the hoof of an ungulate, and whereby said first surface produces a smooth, even finish on the hoof.

8. A combination rasping/filing tool having a longitudinal axis a length and a width, and comprising:
an axially extending blade having first and second surfaces and proximal and distal ends;
said first surface having a plurality of rasping teeth extending a substantial extent of the length of said blade, each individual rasping tooth defining a rasping cavity projecting below said first surface and having a raised portion projecting away from said first surface a height h and at an angle θ with respect to said first surface, said raised portion having a trailing shoulder portion extending proximally away from and contiguous with a sharpened rasping ledge and a rasping face contiguous with said rasping ledge, said rasping face projecting into said rasping cavity and defining a bottommost point of said rasping cavity, wherein each rasping tooth is arranged in a row of eight teeth extending substantially the entire width of said blade, each row is staggered in relation to proximally and distally neighboring rows such that a proximal-most end of said trailing shoulder of each rasping tooth in one row is received adjacent said rasping cavity of at least one tooth in a proximally neighboring row.

9. The combination rasping/filing tool of claim 8, wherein said first surface has a length selected from a range between approximately 13.5 inches and approximately 15 inches, and a width selected from a range between approximately 1.625 Inches and approximately 1.875 inches.

10. The combination rasping/filing tool of claim 8, wherein the height h is selected along a range between approximately 0.047 inches and approximately 0.037 inches.

11. The combination rasping/filing tool of claim 8, wherein a plurality of side ridges project laterally from a longitudinal periphery of said blade, each ridge spanning a depth of said blade between said first and second surfaces.

12. The combination rasping/filing tool of claim 8, wherein said second surface has a first plurality of filing ridges oriented parallel to one another in a first angular direction with respect to the longitudinal axis, and a second plurality of filing ridges oriented parallel to one another in a second angular direction with respect to the longitudinal axis and intersecting said first plurality of filing rows, wherein said first angular direction is transverse to said second angular direction, and said first and second filing rows form a plurality of scalloped filing teeth where said first and second rows intersect.

13. The combination rasping/filing tool of claim 12, wherein said first and second surfaces are configured for use on the hoof of an ungulate, and whereby said first surface produces a smooth, even finish on the hoof.
